(19) United States
(12) Patent Application Publication
(10) Pub. No.: US 2008/0113328 A1
(43) Pub. Date: May 15, 2008

(54) COMPUTER ASISTED LEARNING DEVICE AND METHOD

(76) Inventor: Lang Feng, (US)

Correspondence Address: FRANK F. TIAN, 331-4A THIRD AVENUE, LONG BEACH, NJ, 07740, US

(21) Appl. No.: 11/559,384

(22) Filed: Nov. 13, 2006

(51) Int. Cl. G09B 7/00

(52) U.S. Cl. 434/350; 434/362

(57) ABSTRACT

A computer assisted learning system is provided. The system comprises a predetermined learning structure; a set of nodes based on the learning structure, each node having at most three sub-nodes associated therewith; and a group interaction environment for users or students to interact among themselves, or with a system administrator or an expert.

### BACKGROUND OF THE INVENTION

1. Field of the Invention

The invention pertains to the field of learning. More particularly, the invention pertains to a computer assisted learning system.

2. Description of Related Art

Computer assisted word learning is known. U.S. Pat. No. 6,890,181 to Warneke, et al. discloses a methods and systems for delivering multimedia learning modules to one or more students in a computer based education environment. The multimedia education system includes a host server, communication link connecting the host server to a remote computer, and software operable on the host server and remote computer. Methods include providing: a set of global knowledge/vocabulary words with high interest expository text and graphics; a contextual definition for at least one of the words; or an additional set of vocabulary words presented as a pair of synonyms for a new stimulus word. A method includes causing a student to select an appropriate synonym to replace the stimulus word based on another high interest expository text. A method includes providing a game scenario including a multisensory scenario, wherein the student must select an appropriate synonym or a pair of synonyms from a number of synonyms to complete a task in a game.

E-learning involving a teacher and a group of students using a method and system for online teaching using web pages is known. U.S. Pat. No. 6,898,411 to Ziv-el, et al. discloses a teaching and learning method and system communicates exercises, including URL's of Web pages and questions related thereto. Each exercise is distributed by the teacher's computer, synchronously, or downloaded by a student computer, asynchronously. An indicator used on the Web page of one computer can be viewed on the same Web page displayed on the other computers. Responses are processed by the response server and by comparison and evaluation logic, and displayed contemporaneously on the teacher's computer, together with scoring information and with URL's associated with links used on each student computer. Scores are awarded automatically, or arbitrarily by clicking on the screen of the teacher's computer. A feedback signal may appear on the student computer with each keystroke to indicate its correctness. Responses selected on the teacher's computer may be viewed on the student computers or on a Class Display.

However, there is a need or an improvement over the existing learning system in which peer-to-peer interaction are not only provided, but also encouraged.

### SUMMARY OF THE INVENTION

A computer assisted learning system having a predetermined learning structure is provided.

A computer assisted learning system having a set of nodes based on the learning structure for suitable learning process is provided.

A computer assisted learning system having a group interaction environment for users or students to interact among themselves, or with a system administrator or an expert is provided. The group interaction environment possesses a built in incentive structure for inducing learning and usage.

A method in a computer assisted learning system incorporating the features of the system therefore is provided.

A computer assisted learning system is provided. The system comprises a predetermined learning structure; a set of nodes based on the learning structure, each node having at most three sub-nodes associated therewith; and a group interaction environment for users or students to interact among themselves, or with a system administrator or an expert.

A computer assisted learning system having a method therein is provided. The method comprising: to provide a predetermined learning structure; to provide a set of nodes based on the learning structure, each node having at most three sub-nodes associated therewith; and to provide a group interaction environment for users or students to interact among themselves, or with a system administrator or an expert.

### BRIEF DESCRIPTION OF THE DRAWING

FIG. 1 shows a computer assisted learning system.

FIG. 2 shows block diagram of the present invention.

FIG. 2A shows an exemplified, detailed description of part of FIG. 2.

FIG. 2B shows another exemplified, detailed description of part of FIG. 2.

FIG. 3 shows a learning aid structure having a pyramid construction.

FIG. 4 shows a graph suitable for a GUI (graphic user interface.

FIG. 4A shows a detailed FIG. 4.

FIG. 5 shows a generic graph depicting an interrelationship of the present invention.

FIG. 5A shows a detailed depiction of part of FIG. 5.

FIG. 6 shows a first example of the present invention.

FIG. 6A shows a partial first example of the present invention.

FIG. 6B shows a partial first example of the present invention.

FIG. 6C shows a partial first example of the present invention.

FIG. 6D shows a partial first example of the present invention.

FIG. 6E shows a partial first example of the present invention.

FIG. 6 shows a partial first example of the present invention.

FIG. 6F shows a partial first example of the present invention.

FIG. 6 shows a partial first example of the present invention.

FIG. 6G shows a partial first example of the present invention.

FIG. 6H shows a partial first example of the present invention.

FIG. 6I shows a partial first example of the present invention.

FIG. 6J shows a partial first example of the present invention.

FIG. 7 shows a second example of the present invention.

FIG. 7A shows a partial second example of the present invention.

FIG. 7B shows a partial second example of the present invention.

FIG. 7C shows a partial second example of the present invention.

FIG. 8 shows a block diagram of the present invention.

FIG. 9 shows a network structure for learning of the present invention.

FIG. 10 shows a flowchart of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a computer assisted learning system having a predetermined learning structure. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a computer assisted learning system having a predetermined learning structure described herein. The non-processor circuits may include, but are not limited to, a radio receiver, a radio transmitter, signal drivers, clock circuits, power source circuits, and user input devices. As such, these functions may be interpreted as steps of a method to perform the provision of a computer assisted learning system having a predetermined learning structure. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

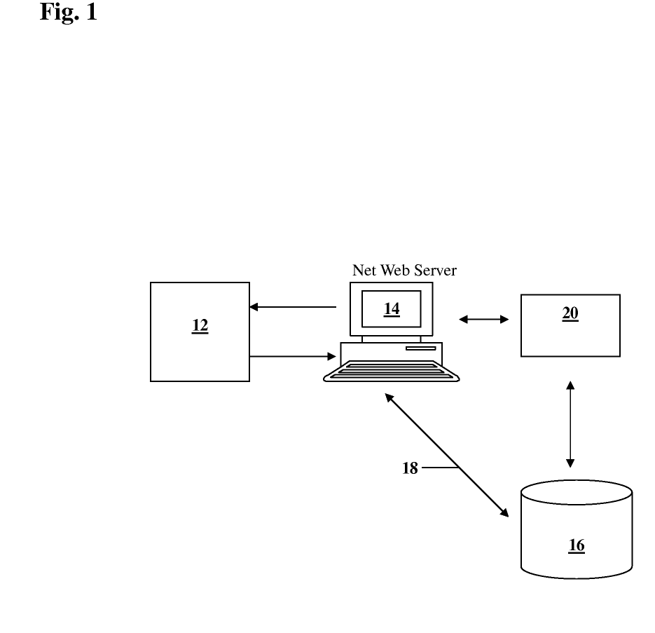

Referring to FIG. 1, a computer assisted learning system is provided. A browser 12 is provided for intercoupling with a 14. Web server 14 may be coupled to a network network 20 such as a WAN (Internet). A data base 16 is informationaly coupled to network 20. Alternatively web server 14 may be coupled directly to data base 16 via coupling 18. 18 may be a LAN. Network 20 May be HTML/ASP.NET/SQL, HTML/Apache+PHP/SQL ruby on rails, or HTML/JSP/SQL

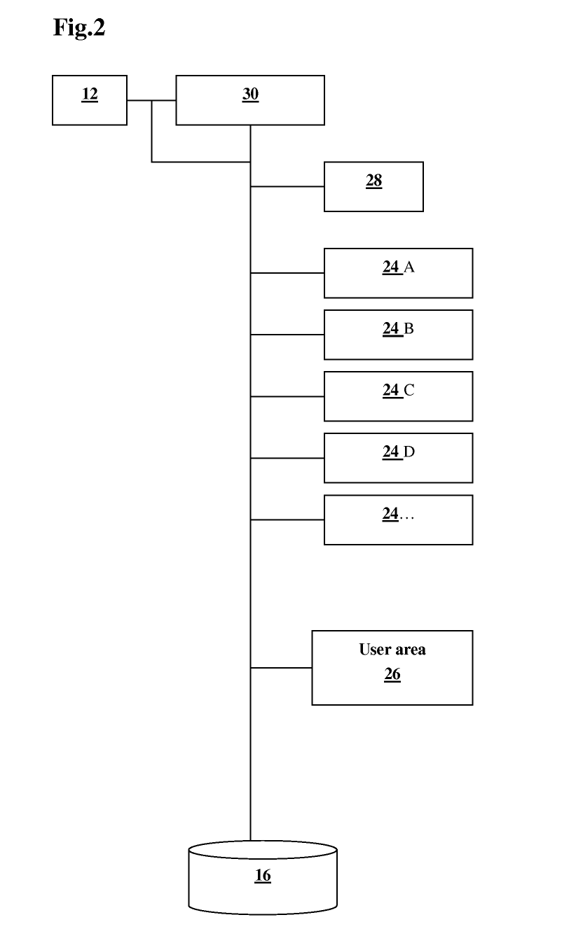

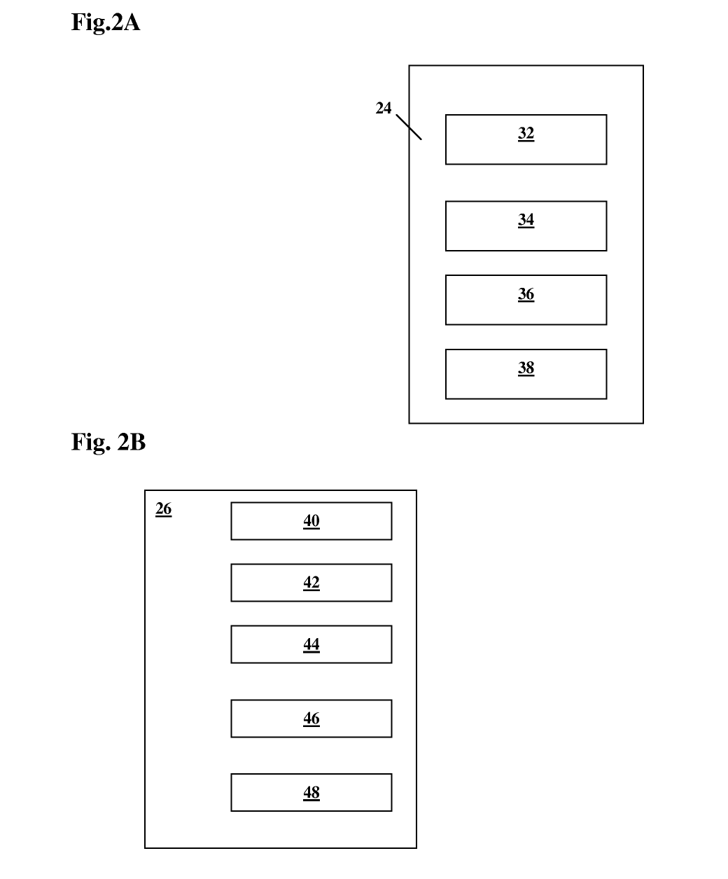

Referring to FIG. 2, browser 12 is coupled to an interconnect or network bus 22 having elements of the present invention coupled thereto. The elements include 24, specialized personal block 26, and sign-up block 28 coupled thereto. Data base 16 is also one element coupled with interconnect or network bus 22. A 30, the structure of which will be described in detail infra, is also one element coupled with interconnect or network bus 22.

Referring to 2A, an exemplified, detailed description of 24 may be as follows. Common suggestion block 32 suggests that student may offer new topics for discussion, etc. And are rewarded with points or have the suggestions entered into a WIKI system. In block 34 students are given points for answering the questions posed. If the answer is desirable, be entered into WIKI system. Otherwise, a student can bid or bid out the points for others to answer same. Block 36 offers new ideas, question, and any member of the group are encouraged to solve or answer same. The offerers are given points, and the offerrees are subtracted points. Alternatively, if the answer is desirable, be entered into WIKI system. In block 38 system manager may divided members into groups. Assign a group head or master. The rest of the members are students or apprentices. Set the par min graduation standard. Offer a token such as a color tie to wear as a symbol for attaining a predetermined status.

Point accumulation system of the present invention encourages members to offer opinions, enter discussions, or provide solutions to a given problem. The addition and subtraction of points serves as an incentive for further improving the system as a whole, as well as benefiting members individually. When points are accumulated to a predetermine level, the member's status is raised to such titles as assistant manger, or as fees for other class or topic.

Referring to FIG. 2B, an exemplified, detailed description of 24 may be as follows. 40 is a place where a plurality of participants or students has a concurrent discussion. Block 42 contemplates an one-on-one interaction. Both blocks 42 and 40 have a set of information suitable for display, wherein the display is accessible by others. Block 44 provides video communications for “face-to-face” interactions via systems similar to MSN Messenger. Block 46 provides individual understandings of a paper based textbook including providing save to the system, with the same's feedback. The feedback includes the differences between an individual user's understandings and the systems take or understanding of a similar topic and idea. The system further provides feedback to the individual with questions and/or prompts. Block 48 provides a data base relating to a specific user including at least one mailbox, user's learning records, managing individuals information for non-private access.

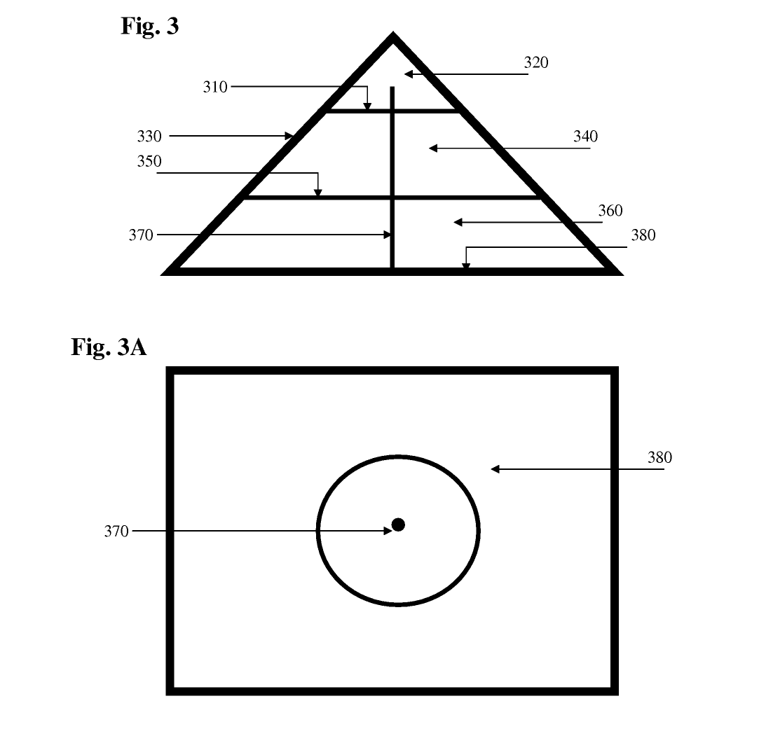

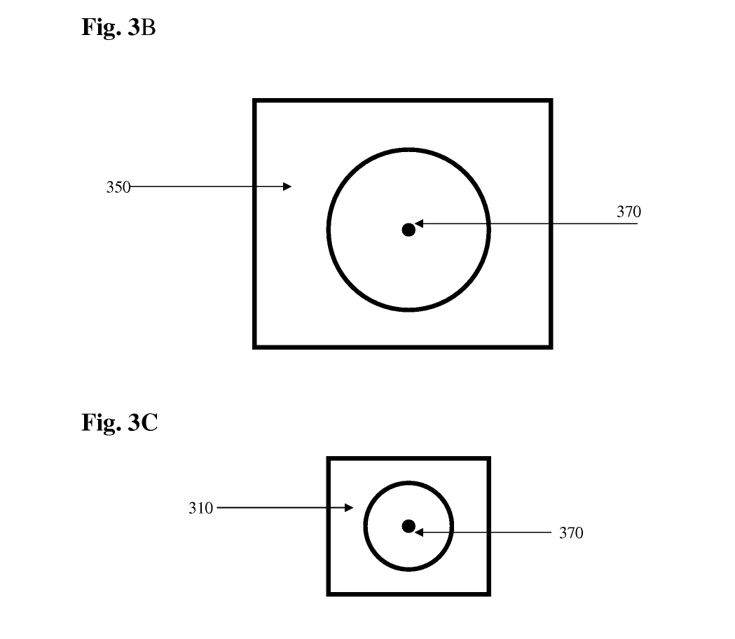

Referring to FIG. 3, learning aid structure 30 having a pyramid construction is depicted. learning aid structure 30 is pre-designed by a designated designer (not shown). learning aid structure 30 provides a predetermine structure for learning a predetermined topic. learning aid structure 30 has an upper level 320, middle level 340, and lower level 360. Interface 310 is interposed between upper level 320 and middle level 340. In interface 310, there are topics relating to linguistics, or symbols relating to a topic. Interface 350 is interposed between lower level 360 and middle level 340. In middle lower level interface 350, there are topics relating to mathematics related things. In column 370, there are topics relating to life science. Note that column 370 transcends both upper interface 310 and middle lower level interface 350. In natural science basement 380, a base denoting natural science is provided. A set of three circles are provided. Circle 301 on natural science basement 380, circle 302 on middle lower level interface 350, and circle 303 on upper interface 310 define a cylinder 304. An outer layer 330 covers learning aid structure 30.

As can be seen, learning aid structure 30 together with upper interface 310, middle lower level interface 350, and natural science basement 380 define three inner spaces. The inner spaces are lower space within lower level 360, middle space within 340, and upper space within upper level 320.

In lower level 360, two major groups comprising applied science (including engineering) and basic science are provided. The applied sciences are distributed upon the bases of natural science basement 380. Above the natural science basement 380, corresponding basic science groups are provided. Every basic science group has four layers for subdividing said group further into subtopics. This is because some basic science groups possess complex characteristics. Upon the base of natural science basement 380 and within 304, there is column 370 denoting life science related groups or topics. Column 370 is structure according to life science layers from base upward such as single cell layer, large molecules layer, microorganism layer, plant layer, animal layer, human layer, and social layer (all of them not shown). Surrounding column 370 at different heights are there respective medical, pharmacological, or agricultural related topics. Each 24 may be considered a group.

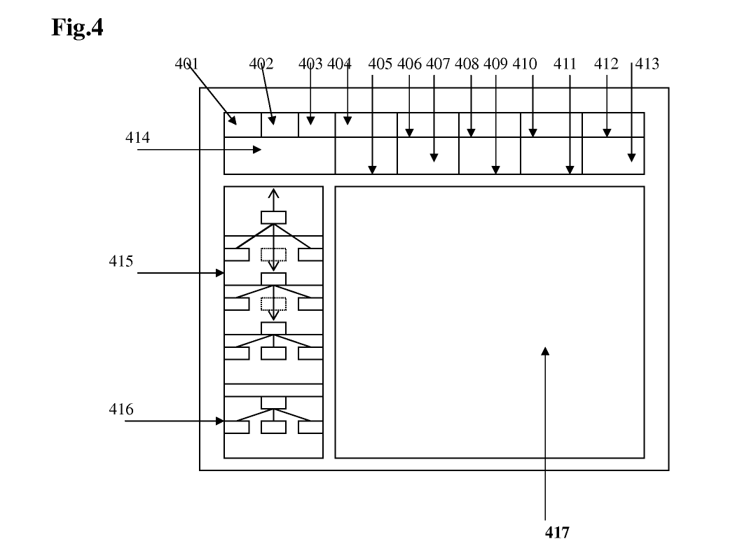

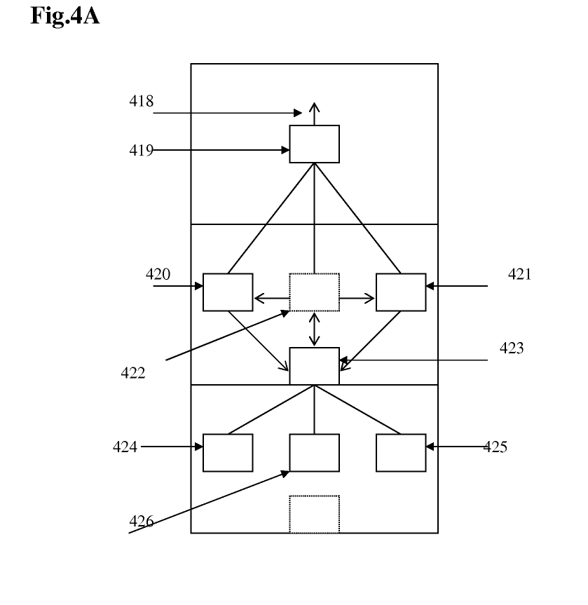

Referring to FIGS. 4 and 4A, a graph 400 suitable for a GUI (graphic user interface) or a display on a displaying means such LCD or CRT or any suitable displayer is provided. In block 414 a general topic such as a science topic is displayed therein. Alternatively, in block 414, any subtopic such as a question may be displayed therein. A student or a user may enter her input therein for submission pending a further determination. Block 414 is the topic of the name of a class or a name for any object suitable to be a title, main topic, special topic, or question, etc. Block 401 is associated with comprehension. Block 402 is associated with technique. Block 403 is associated with emotional domain. Block 401, block 402, and block 403 are all associated with block 414. Blocks 405, 407, 409, 411, and 413 are analytics elements associated with file block 404, editing block 406, inspection block 408, insertion block 410, and form block 412. Blocks 405, 407, 409, 411, and 413 are analytics elements is also associated with their respective concepts relating to blocks 401,402, and 403 respectively, and the content of which are adapted to be displayed within GIU 400. Block 414 is the topic of the name of a class or a name for any object suitable to be a title, main topic, special topic, or question, etc. Block 401 is associated with comprehension. Block 402 is associated with technique. Block 403 is associated with emotional domain. Block 401, block 402, and block 403 are all associated with block 414. Blocks 405, 407, 409, 411, and 413 are analytics elements associated with file block 404, editing block 406, inspection block 408, insertion block 410, and form block 412. Blocks 405, 407, 409, 411, and 413 are analytics elements is also associated with their respective concepts relating to blocks 401,402, and 403 respectively, and the content of which are adapted to be displayed within GIU 400.

Block 417 contains the manifestations of making, editing, and practical expressions of contents such as data entered by a user. Block 415 is an accumulation of nodes. At each level of block 415, contents of the node progresses upwards or downwards with each node corresponding to the content of block 417. Block 416 is a temporary area. Within block 416, one can draw conclusions within a smaller unit than that of a main topic. In block 418, nodes may be selected one level up. Block 419 denotes the main topic or the highest level node. Blocks 420, 421, and 422 are the three sub-nodes of block 419. If block 422 is selected, then block 422 moves to the position of block 423. At the same time the three sub-nodes of block 422, i.e. blocks 424, 425, and 426 are shown. Similarly, if block 420 is selected, then block 420 moves to the position of block 423. At the same time the three sub-nodes of block 420 are moved to blocks 424, 425, and 426 respectively. For block 421, similar occurrences occur as above if chosen.

In conclusion, any nodes once chosen such as being highlighted by a user on the left side of GIU 400, the content of which is displayed on the right side of block 417 of GIU 400. A user or student uses this feature for a topic recognition, topic derivation, or topic inclusion determination process. In other words, the user or student is trying to find a converging point of the topic in order to better or more efficiently determine the learning elements of a topic. Simultaneously, the user or student enters data pertaining to each node within area 417 of GIU 400. The above process is a process of understanding a topic. The understanding process is the process of reducing the number of nodes not understood by the user or student to zero.

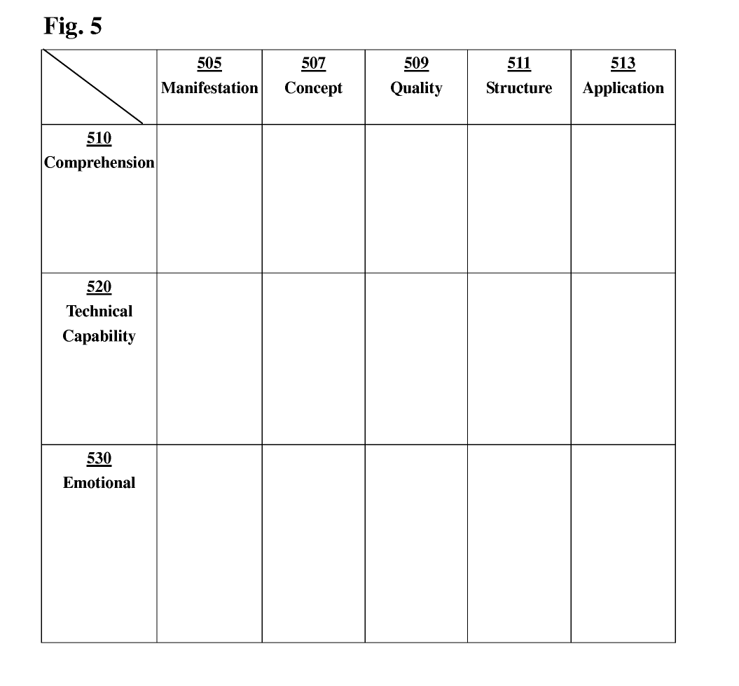

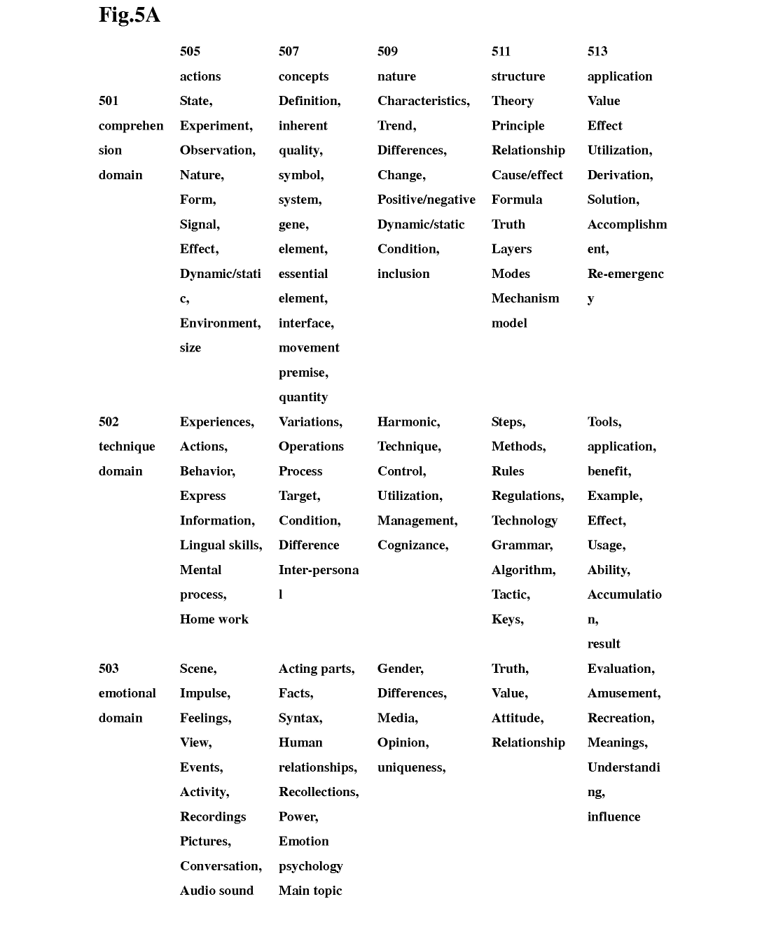

Referring to FIG. 5, a generic graph depicting an interrelationship of the present invention is shown. The interrelationship of three domains with that of five areas is shown. The three domains are comprehension domain, technique domain, and emotional domain. The five areas are manifestation area, concept area, nature area, structure area, and application area.

Referring to FIG. 5A, an exemplified graph depicting an interrelationship of FIG. 5 is shown. Once the learning topic is established, the domain contents or the contents for learning are fixed. In other words, once the object of learning is known, the known points or nodes of 3-1 system are determined. That is to say, once the comprehension system elements are known or established, every analytic element has known associated drop down menu. A student or user may use same for selecting or referencing elements therein. Once submitted, the system only compares the result of the user or student with that of the standard answer or reference in the data base 16. The result of the user or student is associated with the elements or nodes within block 415 of FIG. 4. If the result is sufficiently different from that within database 16, a system warning would be issued. The system warning may be expressed as the node would flicker or be highlight for the user to efficiently observe; thereby proper notification is given to the user, who may be given the choice for correcting same. Of course the system itself is adapted to receive or record this event.

The user may ignore the system warning and continue the learning process. The system administrator is the final arbiter of all system warnings. If the result is sufficiently unique and valuable, system administrator may select the result as a standard or reference answer. The selected result may be stored in data base 16 as the result. Typically, the selected result is initially used as a lower level reference. Once similar references accumulate, a determination will be made as to whether one of them should be the standard or substandard answer. The references are accumulated by prior users or students. The user may buy elements or information contained in data base 16 using points, i.e. tuition points. The elements include standard answers or derivations contain within database 16. But this buying is not encouraged in that the tuition pinots are tuition per se. The system may compare different results from different users in order to discover copying the results among users, including large scale copying. Once identical results are discovered, and copying is determined as positive, the associated users may be penalized, including forfeiting all existing tuition points. Therefore, if the forfeited user wants to reenter the system, she needs to start from the very beginning including paying all the necessary tuitions.

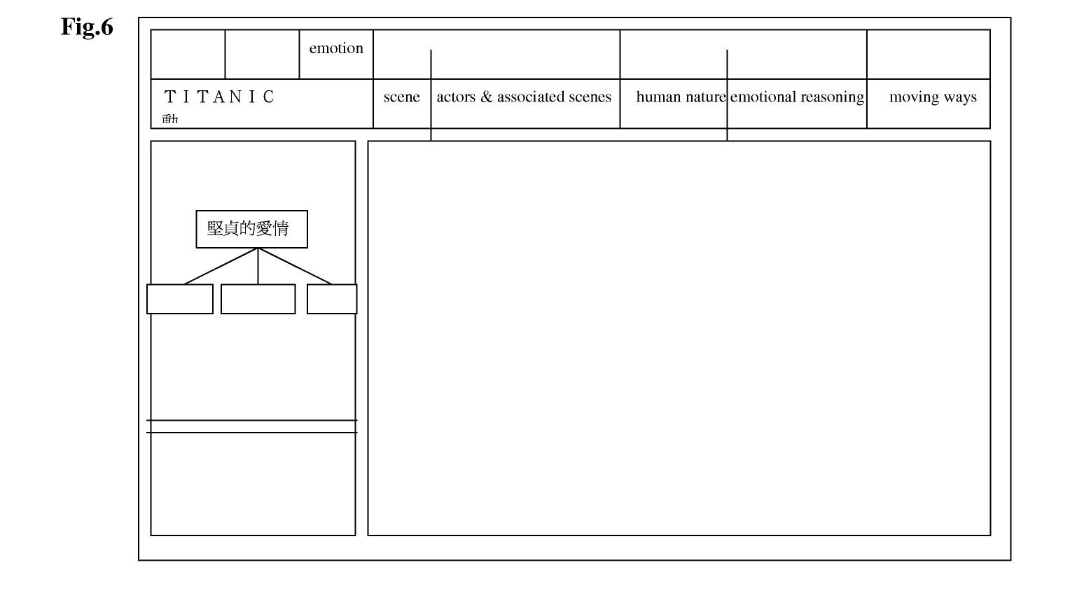

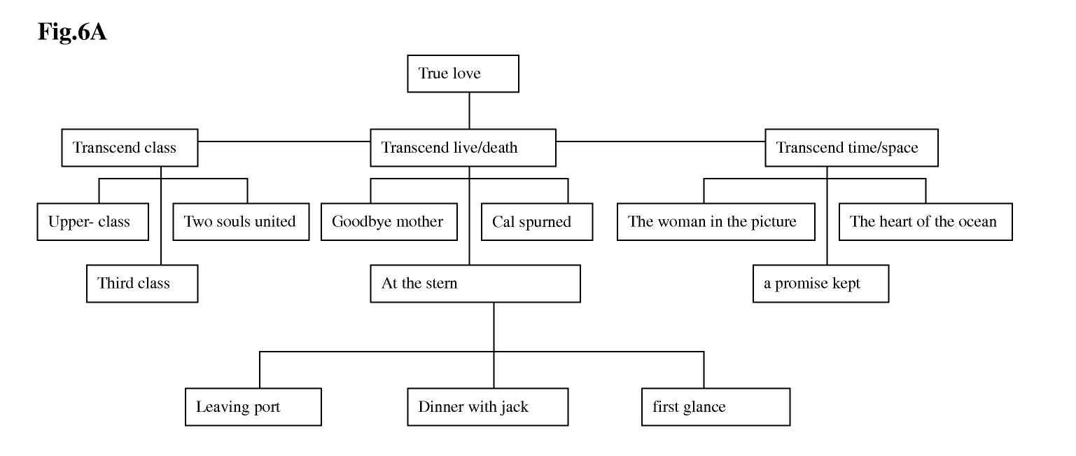

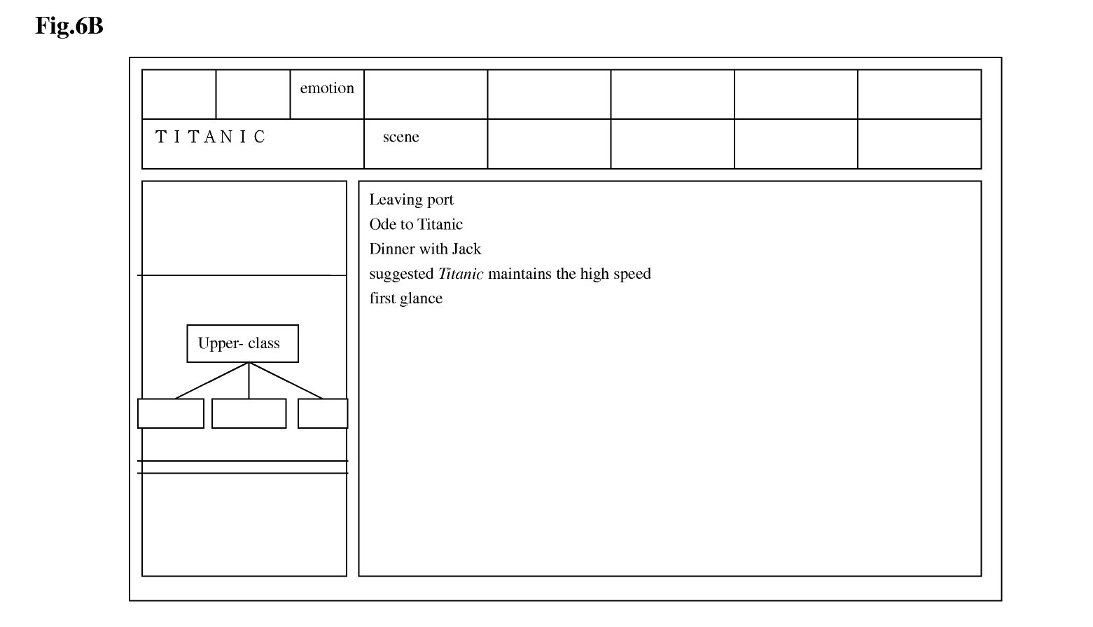

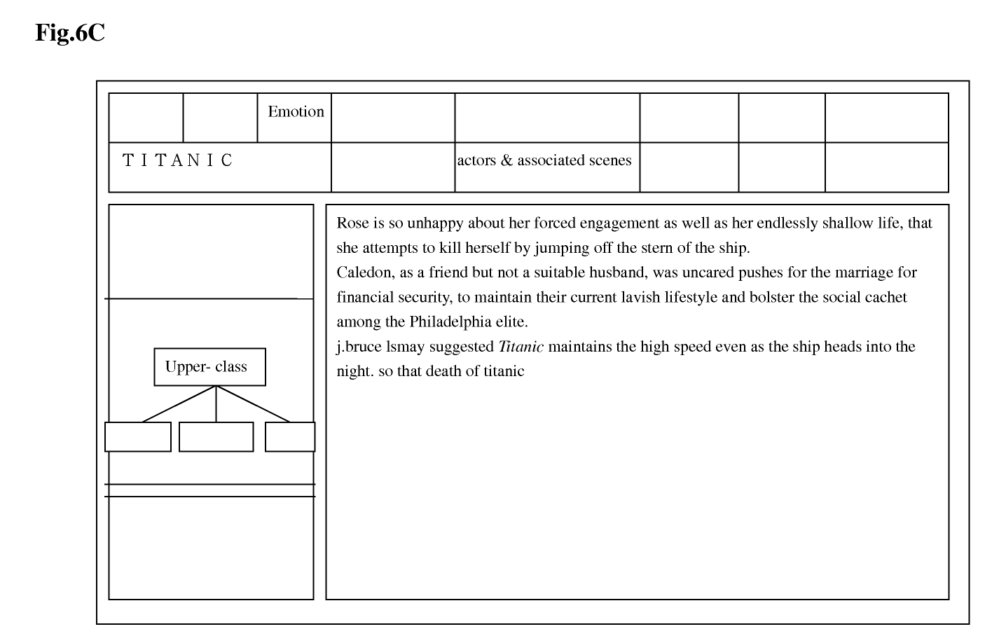

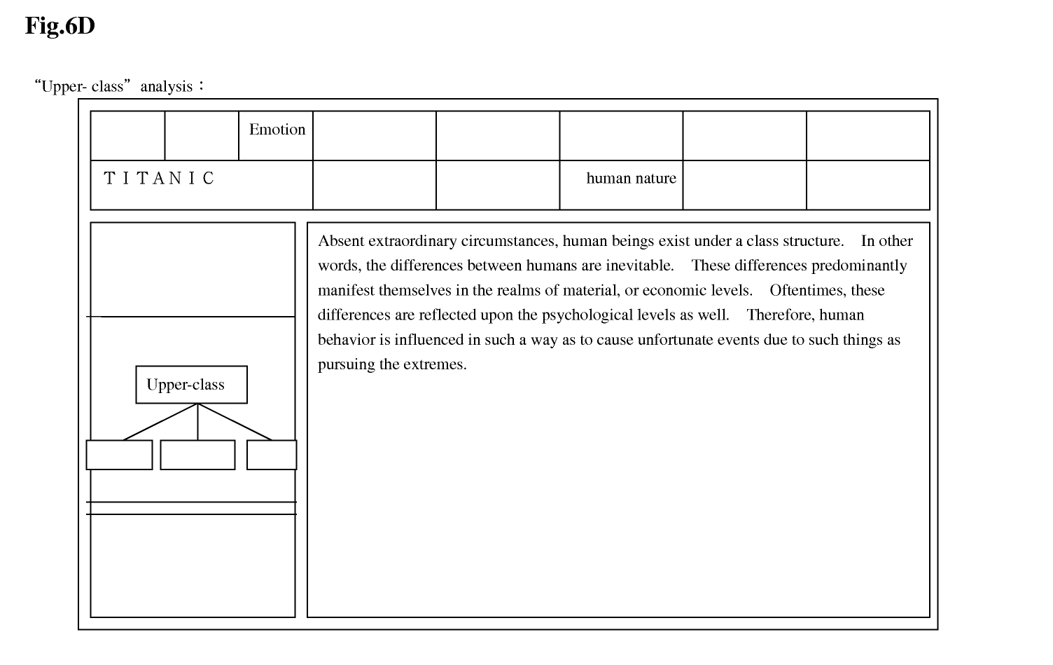

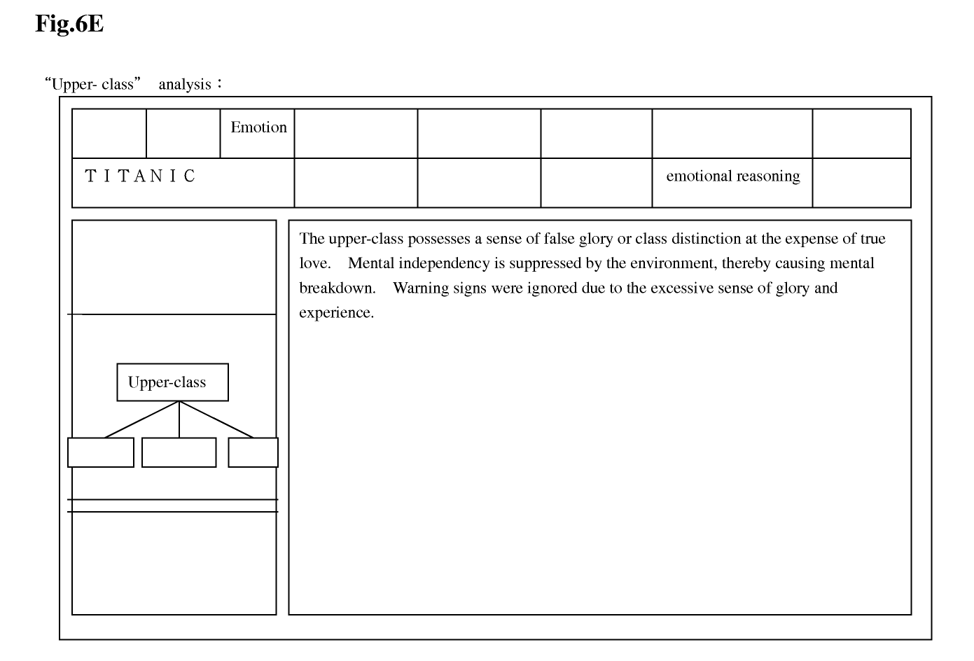

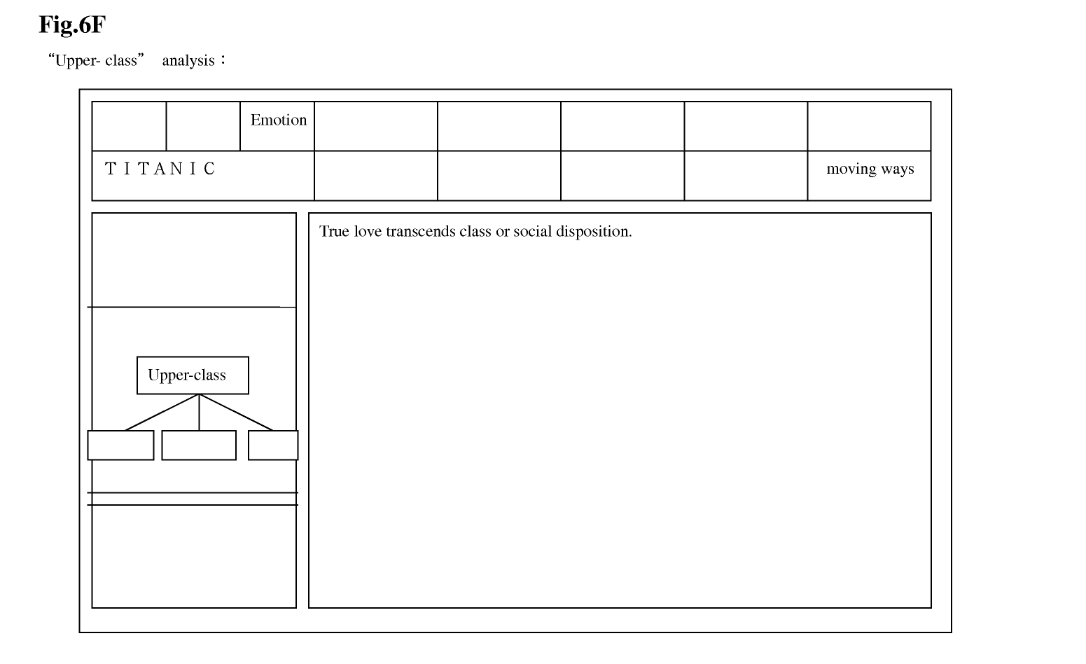

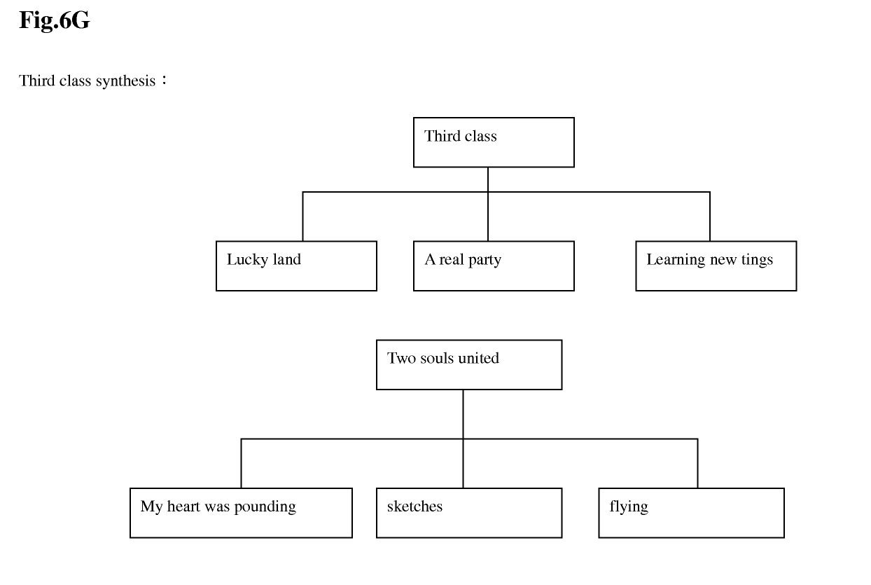

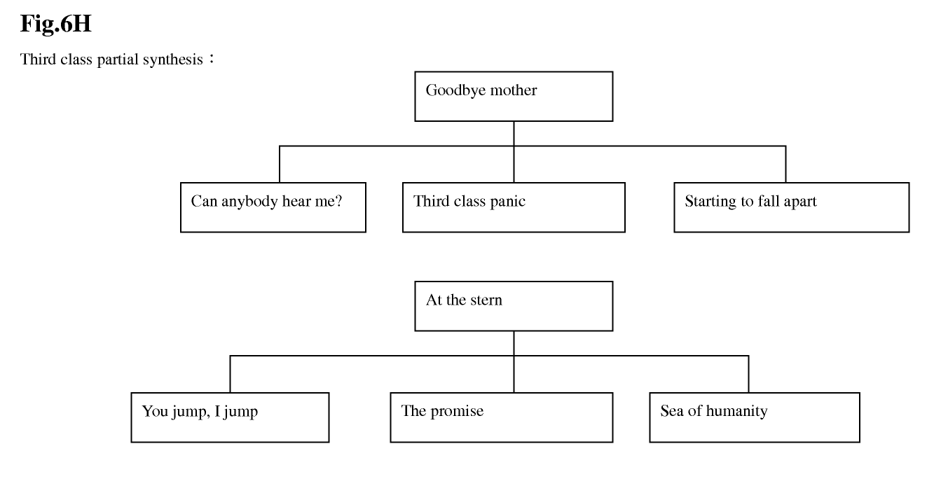

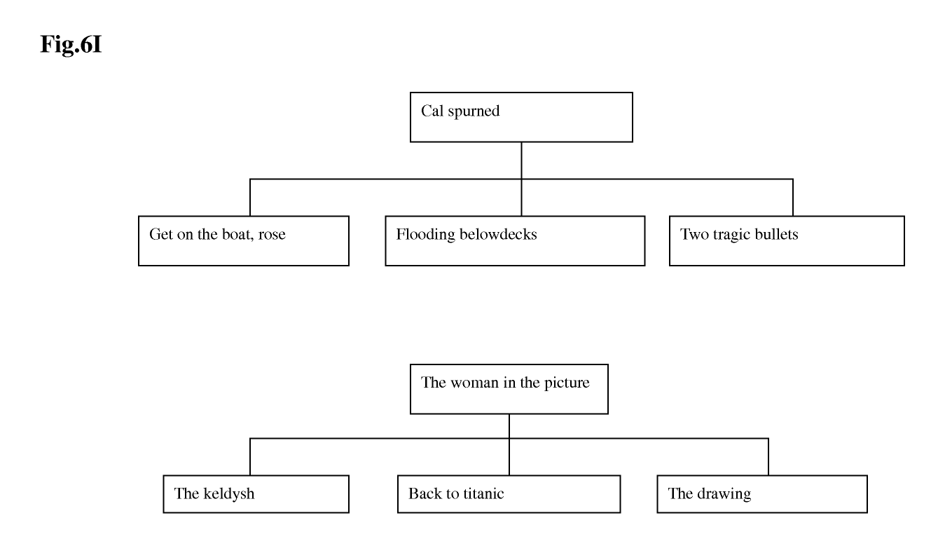

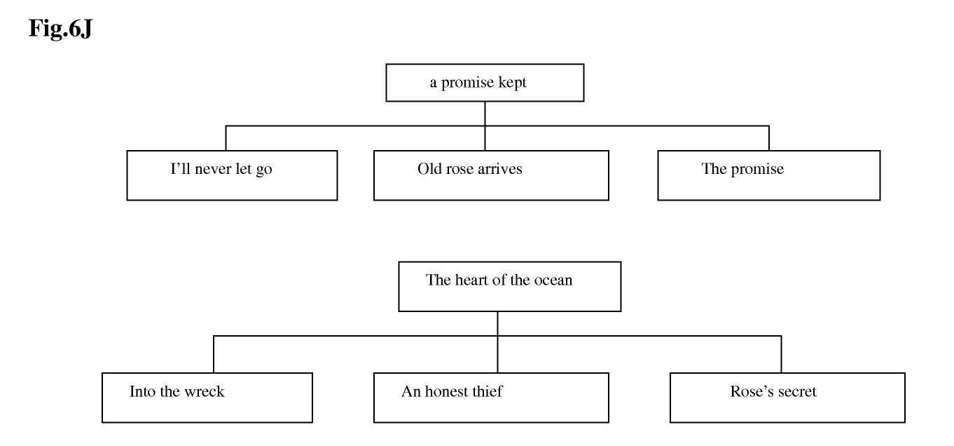

Referring to FIG. 6, a partial first example of the present invention is shown. The movie or the movie story of Titanic is analyzed using the method and system of the present invention.

Referring to FIG. 6A, a partial first example of the present invention is shown. Note that each node has its own analytics. Due to page restrictions, only the analytics for “Upper-class” is shown as an example. The node true love is subdivided into the three sub-nodes of Transcend class, live/death, and time/space. The three sub-nodes is further subdivided into their respective three sub-nodes at a further sub-level. The three sub-nodes are: for class the sub-nodes are Upper-class, Third class, and Two souls united; for live/death the sub-nodes are goodbye mother, at the stern, and Cal spurned; for time/space the sub-nodes are woman in the picture, a promise kept, and heart of the ocean. The sub-node of upper-class is subdivided into the three sub-nodes of leaving port, dinner with Jack, and first glance.

Referring to FIG. 6B, a partial first example of the present invention is shown. More specifically, the GUI of FIG. 4 is shown. The topic upper-class and relevant sub-nodes of emotion, and scene are high lighted. An exemplified entry of data by a user may be as follows: Leaving port, Ode to Titanic, Dinner with Jack, suggested Titanic maintains the high speed first glance.

Referring to FIG. 6C, a partial first example of the present invention is shown. More specifically, the GUI of FIG. 4 is shown. The topic upper-class and relevant sub-nodes of Emotion, actors & associated scenes are high lighted. An exemplified entry of data by a user may be as follows Rose is so unhappy about her forced engagement as well as her endlessly shallow life, that she attempts to kill herself by jumping off the stern of the ship. Calcdon, as a friend but not a suitable husband, was uncared pushes for the marriage for financial security, to maintain their current lavish lifestyle and bolster the social cachet among the Philadelphia elite. j.bruce lsmay suggested Titanic maintains the high speed even as the ship heads into the night. so that death of titanic.

Referring to FIG. 6D, a partial first example of the present invention is shown. More specifically, the GUI of FIG. 4 is shown. The topic upper-class and relevant sub-nodes of human nature, and Emotion are high lighted. An exemplified entry of data by a user may be as follows: absent extraordinary circumstances, human beings exist under a class structure. In other words, the differences between humans are inevitable. These differences predominantly manifest themselves in the realms of material, or economic levels. Oftentimes, these differences are reflected upon the psychological levels as well. Therefore, human behavior is influenced in such a way as to cause unfortunate events due to such things as pursuing the extremes.

Referring to FIG. 6E, a partial first example of the present invention is shown. More specifically, the GUI of FIG. 4 is shown. The topic upper-class and relevant sub-nodes of emotion, and emotional reasoning are high lighted. An exemplified entry of data by a user may be as follows: the upper-class possesses a sense of false glory or class distinction at the expense of true love. Mental independency is suppressed by the environment, thereby causing mental breakdown. Warning signs were ignored due to the excessive sense of glory and experience.

Referring to FIG. 6F, a partial first example of the present invention is shown. More specifically, the GUI of FIG. 4 is shown. The topic upper-class and relevant sub-nodes of emotion, and moving ways are high lighted. An exemplified entry of data by a user may be as follows in that true love transcends class or social disposition.

Referring to FIG. 6G, a partial first example of the present invention is shown. More specifically, a third class partial synthesis is shown. The node Third class is subdivided into the three sub-nodes of Lucky land, a real party, and Learning new things. And node two souls united is subdivided into the three sub-nodes of my heart was pounding, sketches, and flying.

Referring to FIG. 6H, a partial first example of the present invention is shown. More specifically, a third class partial synthesis is shown. The node Goodbye mother is subdivided into the three sub-nodes of “Can anybody hear me?” third class panic, and starting to fall apart. And node at the stern is subdivided into the three sub-nodes of you jump, I jump, the promise, and Sea of humanity.

Referring to FIG. 6I, a partial first example of the present invention is shown. The node Cal spurned is subdivided into the three sub-nodes of Get on the boat, Rose, Flooding the lower decks, and Two tragic bullets. In addition, node the woman in the picture is subdivided into the three sub-nodes of the keldysh, Back to Titanic, and The drawing.

Referring to FIG. 6J, a partial first example of the present invention is shown. The node a promise kept is subdivided into the three sub-nodes of I'll never let go, Old rose arrives, and the promise. In addition, node the heart of the ocean is subdivided into the three sub-nodes of into the wreck, an honest thief, and Rose's secret.

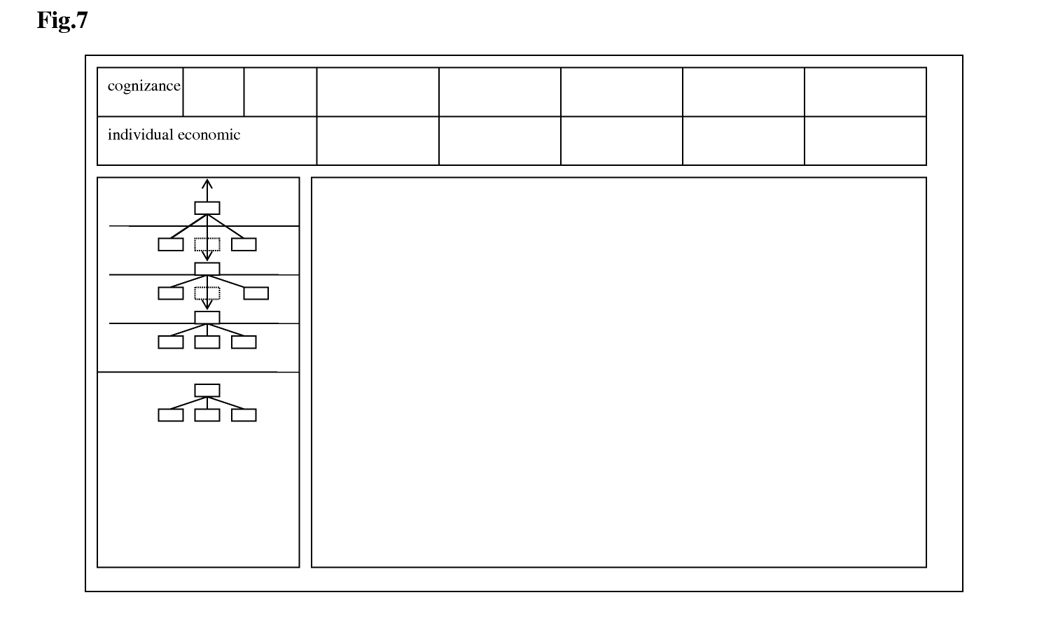

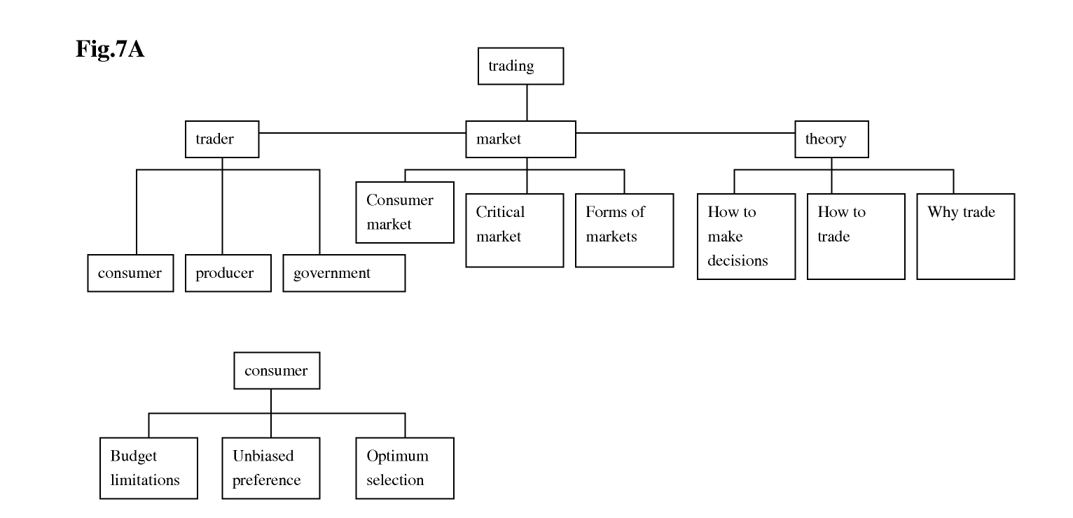

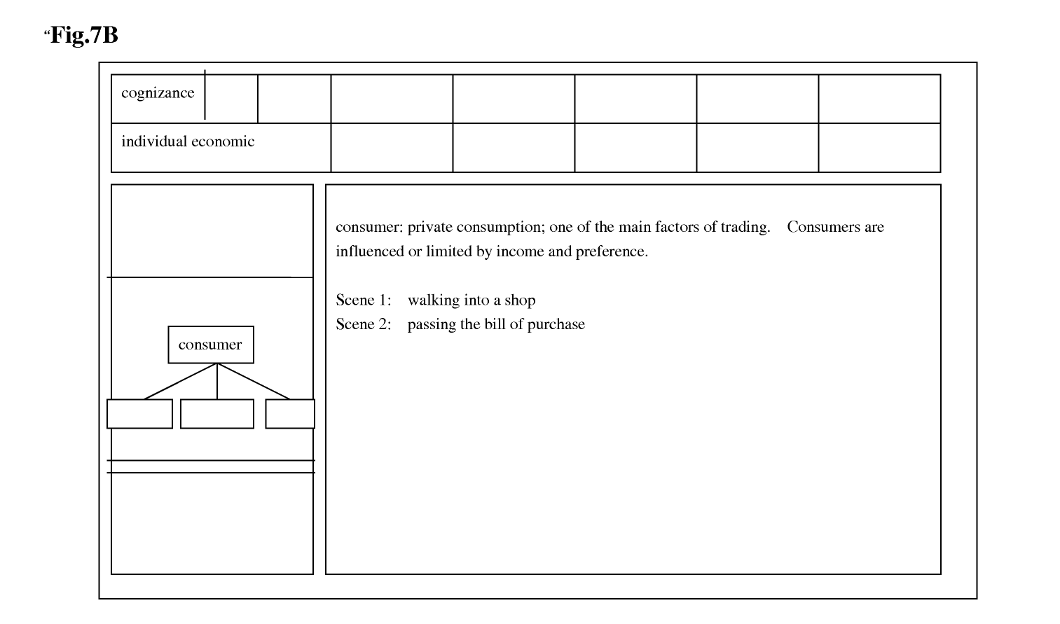

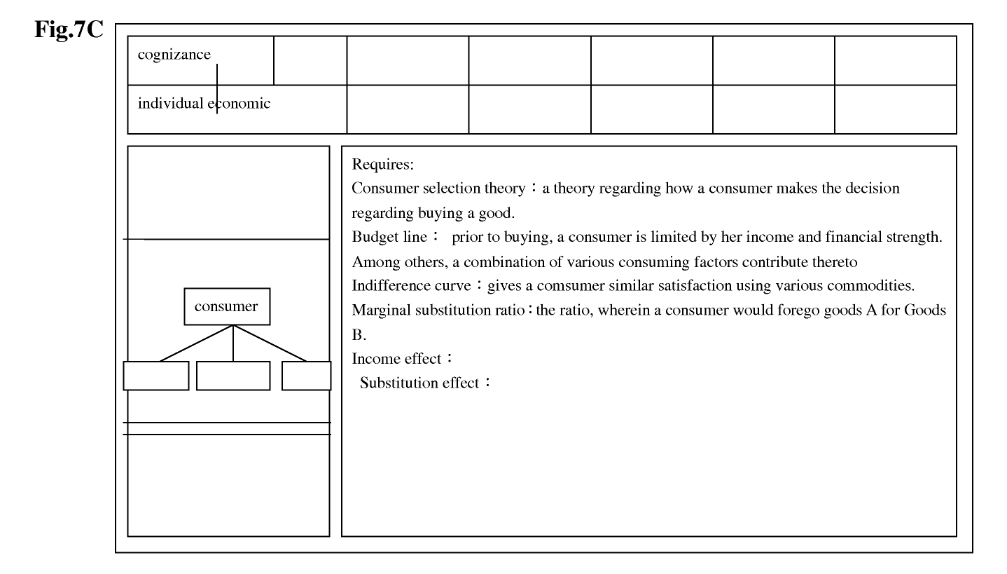

Referring to FIG. 7, a second example of the present invention is shown. It is note that each node has its own sub-nodes in most cases. Due to page limitations, only the node of consumer is exemplified below. Similar with FIG. 6, but having a different topic.

Referring to FIG. 7A, a partial second example of the present invention is shown. Note that each node has its own analytics. Due to page restrictions, only the analytics for “trading” is shown as an example. The node trading is subdivided into the three sub-nodes of trader, market, and theory. The three sub-nodes are further subdivided into their respective three sub-nodes at a further sub-level. The three sub-nodes are: for trader the sub-nodes are consumer, producer, and government; for market the sub-nodes are Consumer market, at Critical market, and Forms of markets; for theory the sub-nodes are How to make decisions, How to trade, and Why trade. The sub-node of upper-class is subdivided into the three sub-nodes of leaving port, dinner with Jack, and first glance. In addition, the node consumer is subdivided into the three sub-nodes of Budget limitations, Unbiased preference, and Optimum selection.

Referring to FIG. 7B, a partial second example of the present invention is shown. More specifically, the GUI of FIG. 4 is shown. The topic individual economics and relevant sub-nodes of cognizance and consumer are high lighted. An exemplified entry of data by a user may be as follows: consumer: private consumption; one of the main factors of trading. Consumers are influenced or limited by income and preference. Scene 1: walking into a shop Scene 2: passing the bill of purchase.

Referring to FIG. 7C, a partial second example of the present invention is shown. More specifically, the GUI of FIG. 4 is shown. The topic individual economics and relevant sub-nodes of cognizance and consumer are high lighted. An exemplified entry of data by a user may be as follows: Requires: Consumer selection theory a theory regarding how a consumer makes the decision regarding buying a good. Budget line: prior to buying, a consumer is limited by her income and financial strength. Among others, a combination of various consuming factors contributes thereto including indifference curve gives a consumer similar satisfaction using various commodities. Marginal substitution ratio is the ratio, wherein a consumer would forego goods A for Goods B. as well as Income effect and Substitution effect.

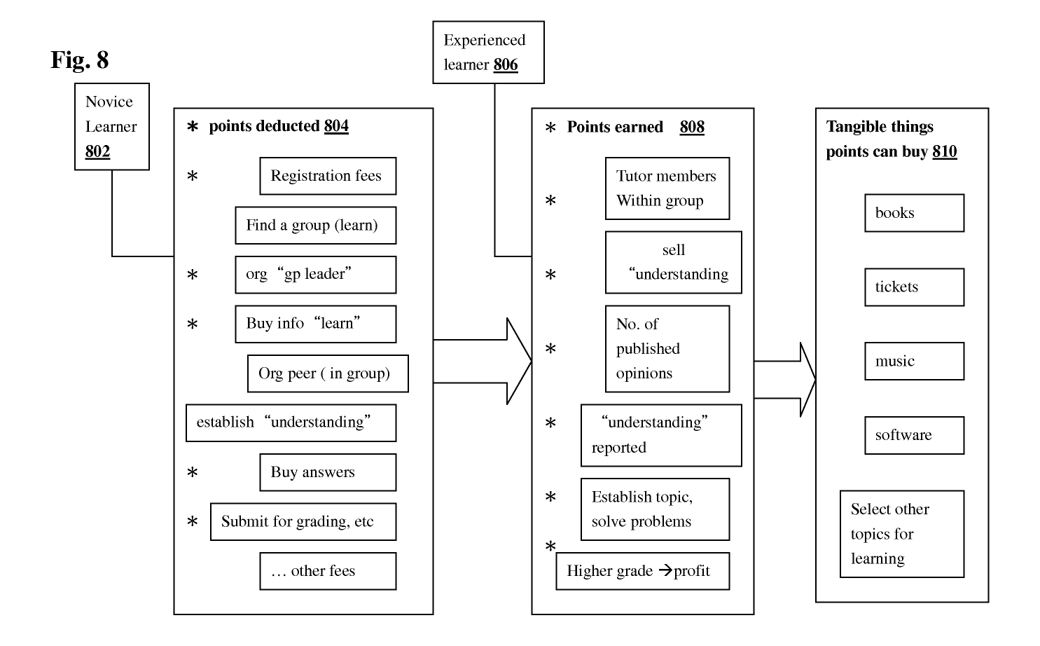

Referring to FIG. 8, a block diagram of the present invention is shown. A novice learner 802 typically needs to go through a set of blocks 804 that requires a fee. Once the novice has graduated to an experience user 806, she can make points by doing such things as teaching others to gain points with topics in block 808. For points gained, the user may use same for purchasing tangible things listed in block 810. Registration fees are required at time of registration. For example, a $100 registration fee, for which 100 points are given. To find a teacher cost points. The teacher herself would accumulate points. The difference between the two is the profit of the learning system of the present invention. Similarly, to buy a standard answer or an understanding of a topic or anything relating to a node or a set of nodes cost points, but selling same gains points. After a book or a topic is subjected to “understanding” by user to a certain degree, an evaluation is done including singling out the creative understandings. A grade is then given to the understandings. Determine or predetermine a level of grade. Above the level points are given; and below the level points are taken. Seek peers or classmates for discussion. The more one speaks among peers or classmates, the more points are gained, and vice versa.

The ones with extra points may use same for purchasing tangible items such as tickets, etc. The ones with a deficit of points may buy more points. The systems of the present invention make a profit by charging a commission for the transaction. Similarly, to establish a topic or solving problems therein gains points. But entering a group, or buying answers or descriptions therein cost points. Furthermore, the answers or any points generating information entered or relating to a user are graded by a grader and give a value relating to more or less points.

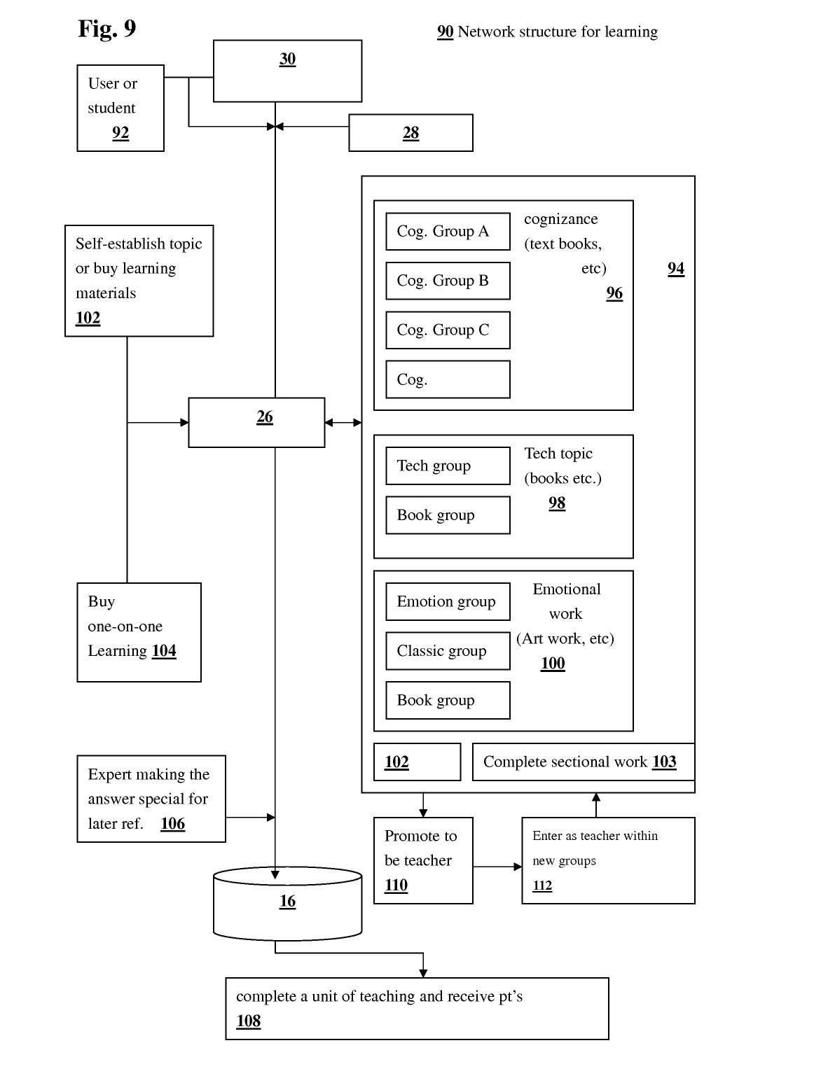

Referring to FIG. 9, a network structure 90 for learning is shown. A 92 enters the system using 30 and via sign in block 28. Through personalized block 26, block 94 wherein group study is performed. Block 94 is subdivided into block 96 wherein cognizance topics are involved. The cognizance topics include primarily text books. Block 96 may including a number of groups such as group A, group B, . . . , etc. Block 94 is further subdivided into block 98 wherein technical topics are involved. The technical topics include primarily books. Block 98 may including a number of groups such as group A, group B, . . . , etc. Block 94 may still be further subdivided into block computerized learning system 100 wherein emotional topics are involved. The emotional topics include primarily literary works. Block 96 may including a number of groups such as group A, group B, . . . , etc. Within block 94, peers may comment on each others' work computerized learning system 102, before completing sectional work computerized learning system 103 on a topic or subtopic. Block 92 may Self-establish topic or buy learning materials computerized learning system 102 or buy one-on-one learning computerized learning system 104. The results of learning may be store in database 16. Before storing in database 16, an Expert may determine the answer special for later reference computerized learning system 106. After the data or information is finished, or completing a unit of teaching, a teacher receives points computerized learning system 108 for her performed work. A user may be promoted to be a teacher 110 because of her performance within the learning system computerized learning system 10. In other words, when she subsequently enters into a group, she has teacher status 112.

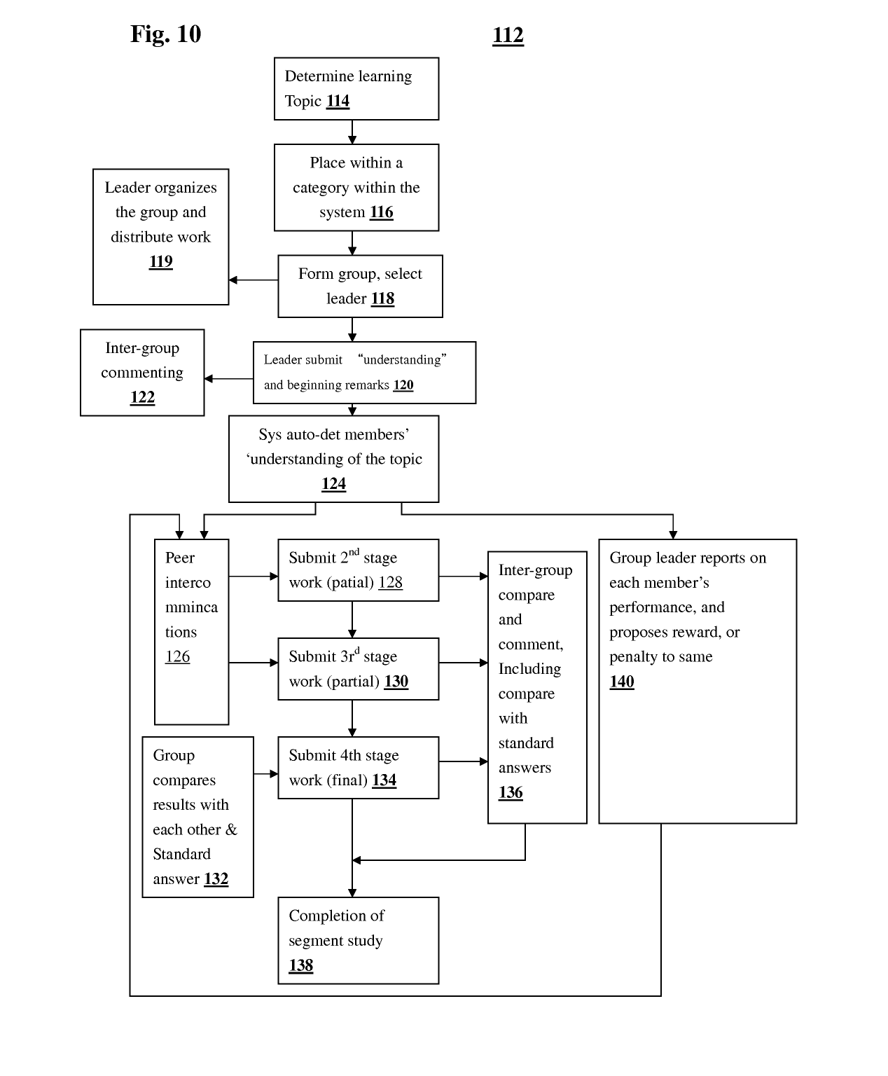

Referring to FIG. 10 computerized learning system 10, a flowchart 112 for learning is shown. A learning topic is determined (Step 114). The learning topic is placed within a category of the computerized learning system 10 (Step 116). Note that if more student than a predetermined number joins a group, the group may be subdivided into parallel groups. Each subgroup may have 3-5 members. To encourage diversity, each subgroup preferably includes as many differences in gender, age, profession, preference, as possible in reference registration information. A group is formed and its leader selected (Step 118). The computerized learning system 10 automatically assigns a group leader by selecting among teachers within the group. In other words, if more than one member within the group qualifies, a lead is chosen among them. The leader's duty may include organizing the group and distribute work within the group (Step 119). The Leader submits “understanding” and beginning remarks for the group to start work (Step 120). Group leader Note that inter-group commenting may be allowed or even encouraged (Step 122). After the users or students have submitted their respective information including comments and answers to posed questions or problems, the system automatically determines the members' ‘understanding of the topic (Step 124). Only members of a group have the right to submit work. The work is subject to peer review (Step 126). A second draft of the work is finished (Step 130). A third draft of the work is finished and submitted for peer review within and without the group (Step 130). Other groups may review the drafts as well (Step 136). A last stage is performed in which the group compares results with each other and the standard answer (Step 132). A final draft of the work is finished and submitted for peer review within and without the group (Step 134). The study of this topic is completed, or one segment thereof is completed (Step 114). Group leader may report on each member's performance, and proposes reward, or penalty to same (Step 140).

Computerized learning system 10 provides a user or student with three choices. The choices are independent study, one-on-one study, and group study. For independent study, also known as seal off study, the user creates work or purchases standard work for study. The work may be commented by others or peers. The rest is similar to other choices of study. For one-on-one study, the user hires a teacher or assistant for learning within computerized learning system 10. She may get a raise and be a teacher if she qualifies.

Work is defined as an ‘understanding’ upon using the computerized learning system 10. The work are evaluated into two levels. At the first level, the computerized learning system 10 automatically determines a grade, a top per centage (e.g. top computerized learning system 10%) of the first level are submitted for the expert to valuate. A selected few may be used as standard models or answers. The accumulated standard models or answers may be used for referencing later users, used as text books, and prompt means, etc.

The co-operative study is accomplished in 2 steps. In step one, a member (including group leader) joins a group and interact within the group for understanding and draft their respective work for further comment. Points are accumulated or reduced as the case may be. Upon completion of the above, step two start by given members teacher status. In the second step, a group can organize members and check or improve her own knowledge regarding the topic. Expert is defined as the few who possess extensive knowledge in their respective field, or exceptional good teachers. Expert may be hired from the outside of computerized learning system 10. Database 16 is organized according to each user, or according to each topic for ease of access. Topics include any class, technical field, liberal arts filed, etc.

In any study action, the member increase or decrease points belonging to her. In actuality, this is a trading system, in other words, a trading among members. The purpose is to offer an incentive for studying. The members who does not want to exert herself or is mentally slow pays more in term of points. On the other hand, the members who works hard and efficiently get paid more in term of points. The excessive points may be converted to real money of real things such as airline ticket, books, etc.

In a computer assisted learning system, a predetermined learning structure is provided. The structure comprises: a substantially three story structure having interfaces between stories, and a transcending substructure transcending the stories; and within the learning structure, a set of graphic elements are provided with each element represent a learning topic, the position of each graphic element representing an interrelationship with other graphic elements.

A computer assisted learning system is provided which comprises: a set of nodes based on a learning structure, each node having at most three sub-nodes associated therewith; a data base for storing prior learning related data associated with the set of nodes; and a GUI (graphic user interface) adapted to display a topic associated with the set of nodes, and adapted for users or students to enter data associated with the set of nodes.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer assisted learning system comprising:
a predetermined learning structure;
a set of nodes based on the learning structure, each node having at most three sub-nodes associated therewith; and
a group interaction environment for users or students to interact among themselves, or with a system administrator or an expert.

2. The system of claim 1 further comprising a data base for storing prior learning related data associated with the set of nodes.

3. The system of claim 1 further comprising a network for connecting at least one user or student with the data base, the learning structure, or at least one user group by transmitting data associated with each node of the set of nodes to a destination for a determination relating to the computer assisted learning system.

4. The system of claim 1 further comprising a GUI (graphic user interface) adapted to display a topic associated with the set of nodes, and adapted for the users or students to enter data associated with the set of nodes.

5. The system of claim 1 further comprising at least one browser for at least one student or user to access or use the computer assisted learning system.

6. The system of claim 1, wherein the predetermined learning structure is a substantially three story structure having interfaces between stories, and a transcending substructure transcending the stories.

7. The system of claim 1, wherein the users or students enter data associated with a node.

8. The system of claim 1, wherein the system administrator or the expert is a final arbiter for the data entered by he users or students.

9. A computer assisted learning system having a method therein, the method comprising:
providing a predetermined learning structure;
providing a set of nodes based on the learning structure, each node having at most three sub-nodes associated therewith; and
providing a group interaction environment for users or students to interact among themselves, or with a system administrator or an expert.

10. The method of claim 9 further comprising providing a data base for storing prior learning related data associated with the set of nodes.

11. The method of claim 9 further comprising providing a network for connecting at least one user or student with the data base, the learning structure, or at least one user group by transmitting data associated with each node of the set of nodes to a destination for a determination relating to the computer assisted learning system.

12. The method of claim 9 further comprising providing a GUI (graphic user interface) adapted to display a topic associated with the set of nodes, and adapted for the users or students to enter data associated with the set of nodes.

13. The method of claim 9 further comprising providing at least one browser for at least one student or user to access or use the computer assisted learning system.

14. The method of claim 9, wherein the predetermined learning structure is a substantially three story structure having interfaces between stories, and a transcending substructure transcending the stories.

15. The method of claim 9, wherein the users or students enter data associated with a node.

16. The method of claim 9, wherein the system administrator or the expert is a final arbiter for the data entered by he users or students.

17. In a computer assisted learning system, a predetermined learning structure comprising:
a substantially three story structure having interfaces between stories, and a transcending substructure transcending the stories; and
within the learning structure, a set of graphic elements are provided with each element represent a learning topic, the position of each graphic element representing an interrelationship with other graphic elements.

18. A computer assisted learning system comprising:
a set of nodes based on a learning structure, each node having at most three sub-nodes associated therewith;
a data base for storing prior learning related data associated with the set of nodes; and
a GUI (graphic user interface) adapted to display a topic associated with the set of nodes, and adapted for users or students to enter data associated with the set of nodes.
